(19) United States
(12) Patent Application Publication
(10) Pub. No.: US 2025/0052104 A1
(43) Pub. Date: Feb. 13, 2025

(54) AUTOMATIC VEHICLE CLOSURE OPERATION WITH 3D ENVIRONMENT MAPPING

(71) Applicant: Atieva, Inc., Newark, CA (US)

(72) Inventor: Nikhilesh Govindarajan, Fremont, CA (US)

(21) Appl. No.: 18/446,940

(22) Filed: Aug. 9, 2023

(51) Int. Cl. E05F 15/40

(52) U.S. Cl. CPC E05F 15/40; E05Y 2400/40; E05Y 2400/44; E05Y 2400/54; E05Y 2900/531

(57) ABSTRACT

A computer-implemented method comprises: collecting, in a vehicle having an advanced driver assistance system (ADAS), sensor data using an ADAS sensor suite of the vehicle, the sensor data collected while the vehicle is moving and reflecting surroundings of the vehicle; generating a three-dimensional (3D) map of the surroundings using the sensor data; defining a boundary condition regarding the vehicle based on the 3D map; and controlling a closure actuator of a closure of the vehicle based on the boundary condition, the closure actuator configured for opening or closing the closure, the closure actuator controlled without the closure having any obstacle detection sensor.

### TECHNICAL FIELD

This document relates to an automatic vehicle closure operation with three-dimensional (3D) environment mapping.

### BACKGROUND

Some vehicles manufactured nowadays are equipped with one or more types of systems that can at least in part handle operations relating to the driving of the vehicle. Some such assistance involves automatically surveying surroundings of the vehicle and being able to take action regarding detected vehicles, pedestrians, or objects. Attempts have been made at providing automatic doors on vehicles that open or close with a motorized mechanism. However, existing automatic doors use one or more dedicated obstacle detection sensors mounted on or within the door. Such dedicated sensor is not used for controlling the motion of the vehicle and is not part of the sensors used by an advanced driver assistance system (ADAS).

### SUMMARY

In a first aspect, a computer-implemented method comprises: collecting, in a vehicle having an advanced driver assistance system (ADAS), sensor data using an ADAS sensor suite of the vehicle, the sensor data collected while the vehicle is moving and reflecting surroundings of the vehicle; generating a three-dimensional (3D) map of the surroundings using the sensor data; defining a boundary condition regarding the vehicle based on the 3D map; and controlling a closure actuator of a closure of the vehicle based on the boundary condition, the closure actuator configured for opening or closing the closure, the closure actuator controlled without the closure having any obstacle detection sensor.

Implementations can include any or all of the following features. The ADAS sensor suite includes at least a camera and ultrasonic sensors, and wherein the camera and ultrasonic sensors are used in collecting the sensor data. The ADAS sensor suite further includes a radar, and wherein also the radar is used in collecting the sensor data. The radar is a short-range radar. Collecting the sensor data comprises performing 3D tracking of the surroundings. Defining the boundary condition comprises generating a boundary polygon surrounding the vehicle. The computer-implemented method further comprises performing a determination that the vehicle is in park mode, wherein the boundary condition is defined in response to the determination. The closure includes a door of the vehicle. Controlling the closure actuator based on the boundary condition comprises opening the closure. Controlling the closure actuator based on the boundary condition comprises closing the closure. The computer-implemented method further comprises receiving a user input to actuate the closure, wherein the closure actuator is controlled in response to receiving the user input. The user input is generated by an application that is executed by a vehicle system or that is executed by a mobile electronic device. The computer-implemented method further comprises performing a first determination, in response to receiving the user input, whether an obstacle exists along a path of an extension of the closure. In response to the first determination indicating that the obstacle exists along the path, the method further comprises performing a second determination of whether the boundary condition is within a distance threshold of the closure. In response to the second determination indicating that the boundary condition is within the distance threshold of the closure, controlling the closure actuator comprises causing the closure actuator not to extend the closure. In response to the first determination indicating that the obstacle does not exist along the path, the method further comprises performing a second determination of whether oncoming traffic exists along the path of the extension of the closure. In response to the second determination indicating that the oncoming traffic does not exist along the path, controlling the closure actuator comprises causing the closure actuator to extend the closure. In response to the second determination indicating that the oncoming traffic exists along the path, controlling the closure actuator comprises causing the closure actuator not to extend the closure. The computer-implemented method further comprises: collecting new sensor data; generating a new 3D map of the surroundings using the new sensor data; defining a new boundary condition regarding the vehicle based on the new 3D map; and controlling the closure actuator based on the new boundary condition, the closure actuator controlled without the closure having any obstacle detection sensor.

In a second aspect, a vehicle comprises: a vehicle body having a closure; an advanced driver assistance system (ADAS); an ADAS sensor suite configured for use by the ADAS, the ADAS sensor suite not including an obstacle detection sensor in the closure; and closure operation logic implemented to be execute by at least one processor, the closure operation logic configured for i) collecting sensor data using the ADAS sensor suite while the vehicle is moving, the sensor data reflecting surroundings of the vehicle, ii) generating a three-dimensional (3D) map of the surroundings using the sensor data, iii) defining a boundary condition regarding the vehicle based on the 3D map, and iv) controlling a closure actuator of a closure of the vehicle based on the boundary condition, the closure actuator configured for opening or closing the closure.

Implementations can include any or all of the following features. The ADAS sensor suite includes at least a camera and ultrasonic sensors, and wherein the camera and ultrasonic sensors are used in collecting the sensor data. The ADAS sensor suite further includes a radar, and wherein also the radar is used in collecting the sensor data. The radar is a short-range radar.

### BRIEF DESCRIPTION OF DRAWINGS

FIG. 1A shows an example of a vehicle having an ADAS sensor suite, and surroundings of the vehicle, wherein a closure is automatically operated without the closure having any obstacle detection sensor.

FIG. 1B shows an example of boundary conditions for the vehicle of FIG. 1A.

FIG. 2 shows an example of a process that can be applied for a first-time engagement of a system that provides automatic closure operation.

FIGS. 3A-3B show examples of a process that can be applied for engaging, when a user is in a vehicle, a system that provides automatic closure operation.

FIGS. 4A-4B show examples of a process that can be applied for engaging, when a user returns to a vehicle, a system that provides automatic closure operation.

FIG. 5 shows an example of a system.

Like reference symbols in the various drawings indicate like elements.

### DETAILED DESCRIPTION

This document describes examples of computer-implemented systems and techniques that provide automatic vehicle closure operation with 3D environment mapping. The automatic closure operation is performed without the closure having any obstacle detection sensor mounted thereon. The vehicle has an ADAS that uses an ADAS sensor suite for controlling motion of the vehicle continuously or from time to time. The ADAS sensor suite is used in creating a 3D map of the surroundings of the vehicle. The system can preload the 3D map and use it to define boundary conditions for the automatic vehicle closure operation. In some implementations, a pre-existing sensor suite in the vehicle as part of an ADAS or autonomous driving package can be used. The system can use an array of corner radars, surround view cameras and/or ultrasonic sensors around the vehicle to create a 3D depth map of the environment and store one or more boundary conditions for the closure extension range. Based on the previously stored environment map, and pedestrian tracking that may also be performed by the vehicle, the decision(s) for closure deployment can be made. That is, some of the vehicle's detection models can be running substantially all the time, including, but not limited to, pedestrian detection, object detection and tracking, stationary object detection, and/or dynamic object detection and tracking. The 3D map includes depth information about the surroundings of the vehicle and can be used (e.g., stored in a cache) in automatic vehicle closure operation.

Examples herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

Examples herein refer to a vehicle closure. As used herein, a closure of a vehicle is a moveable component that selectively prevents (when closed) or enables (when open) egress to at least one region of the vehicle. The vehicle region can be a passenger compartment or a trunk (e.g., positioned at the rear end, at the front end, or elsewhere in the vehicle), or another storage compartment, to name just a few examples. In some implementations, a closure can include a vehicle door, a vehicle trunk lid, a vehicle liftgate, and/or a vehicle hood.

Examples herein refer to an ADAS. In some implementations, an ADAS can perform assisted driving and/or autonomous driving. An ADAS can at least partially automate one or more dynamic driving tasks. An ADAS can operate based in part on the output of one or more sensors typically positioned on, under, or within the vehicle. An ADAS can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of an ADAS, not every ADAS is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., a light ranging and detection (LiDAR) device); a radio-based sensor (e.g., radar); an acoustic sensor (e.g., an ultrasonic device and/or a microphone); an inertial measurement unit (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); a torque sensor; a thermal sensor; a temperature sensor (e.g., a primary or secondary thermometer); a pressure sensor (e.g., for ambient air or a component of the vehicle); a humidity sensor (e.g., a rain detector); or a seat occupancy sensor.

Examples herein refer to a camera. As used herein, a camera includes at least an image sensor to detect visible light, and a lens to focus incoming light onto the image sensor. The image sensor can generate output from which one or more images can be obtained. The information output by the image sensor can have any format or characteristic that is compatible with the system(s) of the vehicle. For example, image sensors can generate output having different image resolutions and/or image qualities.

Examples herein refer to an ultrasonic sensor. As used herein, an ultrasonic sensor includes a transceiver that emits, and detects reflections of, ultrasound energy. The information output by the ultrasonic sensor can have any format or characteristic that is compatible with the system(s) of the vehicle.

Examples herein refer to a short-range radar. As used herein, a radar is a sensor that emits, and detects reflections of, electromagnetic waves in the radio or microwave ranges. As used herein, a short-range radar is a radar having a maximum range of about 30 meters. The information output by the short-range radar can have any format or characteristic that is compatible with the system(s) of the vehicle.

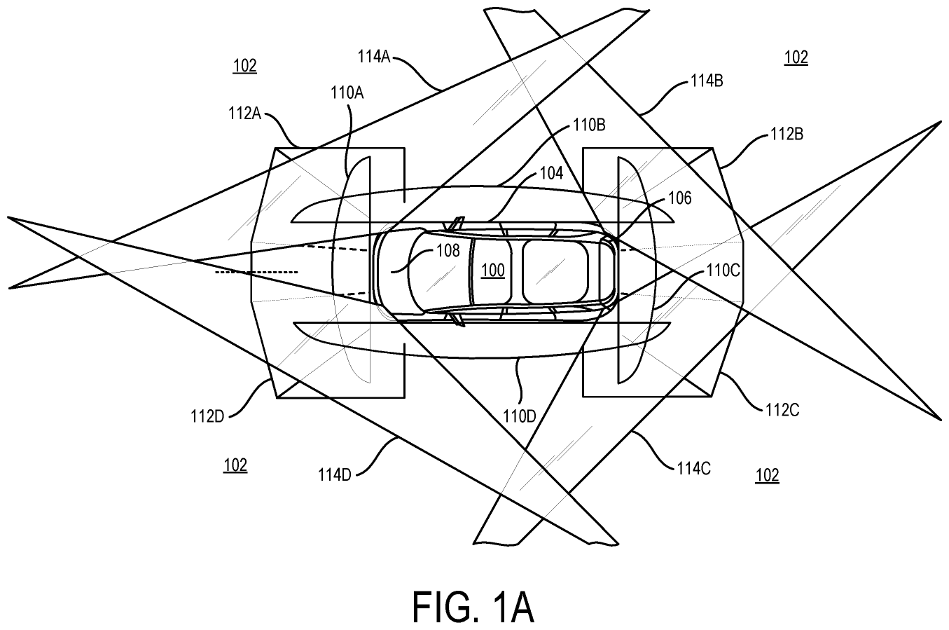

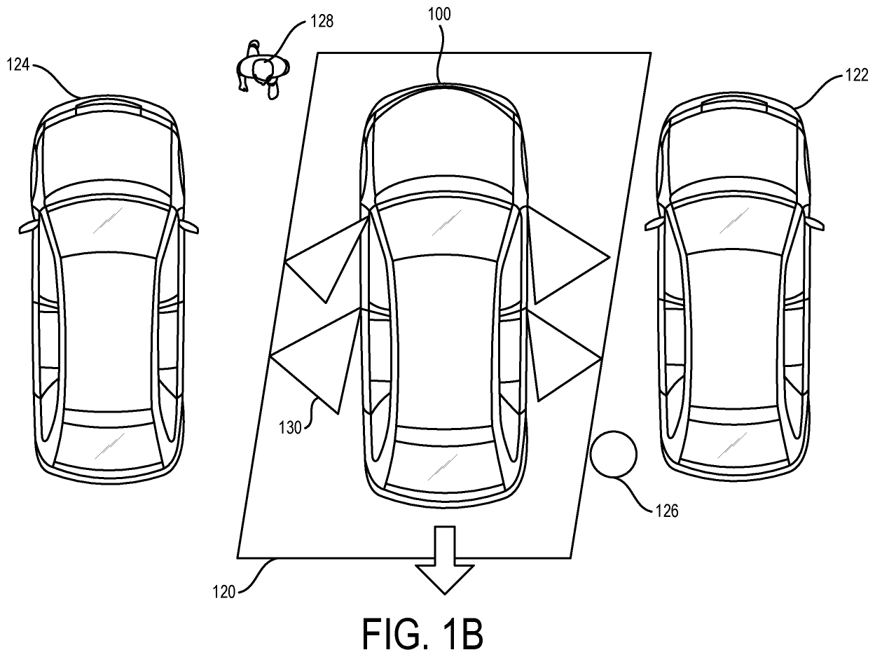

FIG. 1A shows an example of a vehicle 100 having an ADAS sensor suite, and surroundings 102 of the vehicle, wherein a closure is automatically operated without the closure having any obstacle detection sensor. The vehicle 100 and/or the ADAS sensor suite can be used with one or more other examples described elsewhere herein. The vehicle 100 is here shown from above, and the surroundings 102 include all areas in the vicinity of the vehicle 100. The closure can include, but is not limited to, a door 104, a liftgate 106, or a hood 108 of the vehicle.

Sensor modalities of the ADAS sensor suite are shown. Overlapping can occur between two or more of the sensor modalities (e.g., those of the same type of sensor, and/or those of different types of sensor). An image sensor (e.g., a surround-view camera) can have a field of view (FOV) 110A. In some implementations, the FOV 110A can have a semi-elliptical shape. For example, the FOV 110A can be positioned in front of the vehicle 100 and extend wider than the vehicle 100 on either or both sides. Another image sensor can have a FOV 110B. In some implementations, the FOV 110B can have a semi-elliptical shape. For example, the FOV 110B can be positioned on one side of the vehicle 100 and extend farther than the vehicle 100 in either the front or rear or both. Another image sensor can have a FOV 110C. The FOV 110C can be analogous to the FOV 110A and positioned at the rear of the vehicle 100. The FOV 110C can have the same shape as, or a different shape than, the FOV 110A. The FOV 110C can have the same size as, or a different size than, the FOV 110A. Another image sensor can have a FOV 110D. The FOV 110D can be analogous to the FOV 110B and positioned at the opposite side of the vehicle 100. The FOV 110D can have the same shape as, or a different shape than, the FOV 110B. The FOV 110D can have the same size as, or a different size than, the FOV 110B.

An ultrasonic sensor can have a FOV 112A. In some implementations, the FOV 112A can have a polygon shape. For example, the FOV 112A can be positioned at a front right corner of the vehicle 100 and extend some distance(s) forward and to the side of the vehicle 100. Another ultrasonic sensor can have a FOV 112B. The FOV 112B can be analogous to the FOV 112A and positioned at a rear right corner of the vehicle 100. The FOV 112B can have the same shape as, or a different shape than, the FOV 112A. The FOV 112B can have the same size as, or a different size than, the FOV 112A. Another ultrasonic sensor can have a FOV 112C. The FOV 112C can be analogous to the FOV 112B and positioned at a rear left corner of the vehicle 100. The FOV 112C can have the same shape as, or a different shape than, the FOV 112B. The FOV 112C can have the same size as, or a different size than, the FOV 112B. Another ultrasonic sensor can have a FOV 112D. The FOV 112D can be analogous to the FOV 112A and positioned at a front left corner of the vehicle 100. The FOV 112D can have the same shape as, or a different shape than, the FOV 112A. The FOV 112D can have the same size as, or a different size than, the FOV 112A.

A short-range radar (SRR) can have a FOV 114A. In some implementations, the FOV 114A can have a polygon shape. For example, the FOV 114A can originate at a front right corner of the vehicle 100 and extend as essentially an isosceles triangle forward and to the side of the vehicle 100. Another SRR can have a FOV 114B. The FOV 114B can be analogous to the FOV 114A and originate at a rear right corner of the vehicle 100. The FOV 114B can have the same shape as, or a different shape than, the FOV 114A. The FOV 114B can have the same size as, or a different size than, the FOV 114A. Another SRR can have a FOV 114C. The FOV 114C can be analogous to the FOV 114B and originate at a rear left corner of the vehicle 100. The FOV 114C can have the same shape as, or a different shape than, the FOV 114B. The FOV 114C can have the same size as, or a different size than, the FOV 114B. Another SRR can have a FOV 114D. The FOV 114D can be analogous to the FOV 114C and originate at a front left corner of the vehicle 100. The FOV 114D can have the same shape as, or a different shape than, the FOV 114C. The FOV 114D can have the same size as, or a different size than, the FOV 114C.

Once 3D depth information for the surroundings 102 has been obtained through the sensor data, one or more boundary conditions can be defined for closures. FIG. 1B shows an example of boundary conditions for the vehicle 100 of FIG. 1A. The boundary condition(s) can include one or more distance specifications that are relevant for automatically controlling the actuation of the closure(s) of the vehicle 100. The boundary conditions can specify or indicate how far the closure is allowed to be extended, or is not allowed to be extended, from the vehicle 100. In some implementations, the boundary conditions can be visualized as a boundary polygon 120 surrounding the vehicle 100. That is, the boundary polygon 120 can be specified based on the proximity to other vehicles 122 or 124, and/or based on a fixed object, here a pillar 126. For example, the boundary polygon 120 can be specified with (x, y) co-ordinates for each vertex point. The presence of a pedestrian 128 in the surroundings can be tracked by the vehicle's system(s), but may not affect the definition of the boundary polygon 120. Closure extensions 130 for the vehicle 100 are schematically indicated.

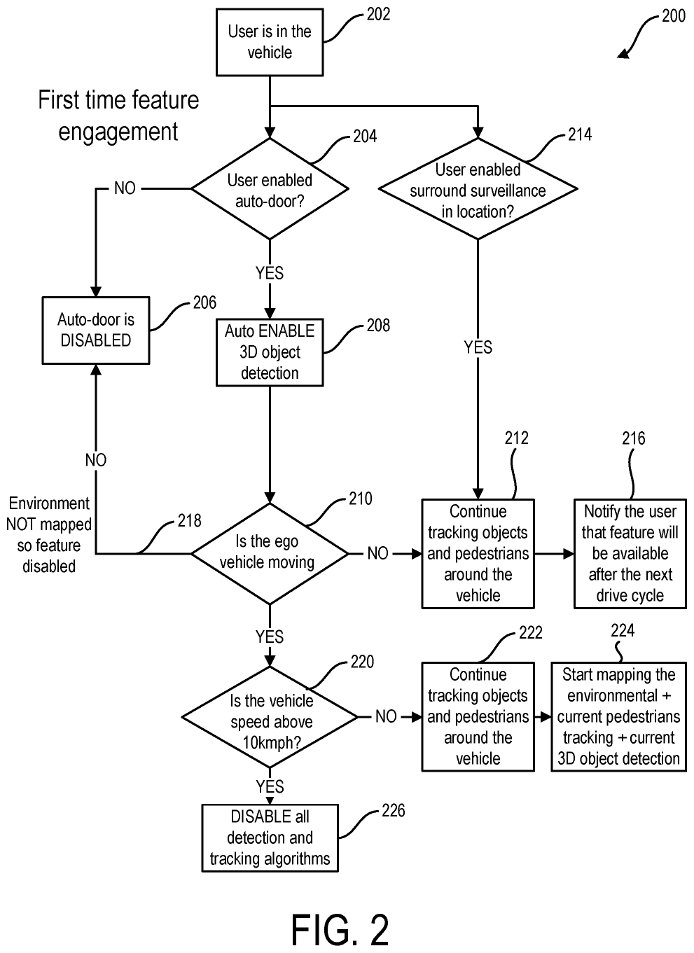

FIG. 2 shows an example of a process 200 that can be applied for a first-time engagement of a system that provides automatic closure operation. The process 200 can be used with one or more other examples described elsewhere herein. More or fewer operations than shown can be performed. Two or more operations can be performed in a different order unless otherwise indicated. Here, engaging the system for the first time indicates that the vehicle does not currently have stored any 3D depth map of its surroundings.

In operation 202, a user is inside the vehicle. In operation 204, the process 200 can determine whether an “auto-door” functionality has been enabled for a closure of the vehicle. The functionality may have been enabled, by the user or another person, using an application on a mobile electronic device coupled to the vehicle, or by an interface of the vehicle's computer system. If the outcome of the determination in the operation 204 is no, then in operation 206 the system state is that the auto-door functionality is currently disabled. If the outcome of the determination in the operation 204 is yes, then in operation 208 one or more detection functionalities can be enabled. In some implementations, 3D object detection is enabled. The 3D object detection can use one or more sensors of the ADAS sensor suite (e.g., one or more types of sensors) to detect the presence of any objects and possibly track their movement. In FIG. 1A, the 3D object detection can be performed with regard to some or all of the surroundings 102 of the vehicle 100.

During the 3D object detection, an operation 210 can be performed where the process 200 determines whether the vehicle (sometimes referred to as the ego vehicle) is currently moving. For example, a speed sensor coupled to a wheel of the vehicle can indicate whether the vehicle is presently moving. If the outcome of the determination in the operation 210 is no, then in operation 212 the process 200 can continue tracking objects and pedestrians around the vehicle. This tracking can be part of a surveillance that the vehicle may be configured to perform unrelated to the automatic operation of closures. For example, an operation 214 can follow after the operation 202 and can include a determination of whether surround surveillance has been enabled for the vehicle. The surround surveillance can be a relatively low-level system activity (e.g., at a slow frame rate) to perform intrusion detection. For example, the surround surveillance can require significantly less system resources than the relatively intensive 3D object and pedestrian tracking that can be performed in the operation 208. In some implementations, pedestrian detection and tracking can be performed using at least one or more cameras (e.g., surround-view cameras). In some implementations, object detection and tracking can be performed using at least ultrasonic sensors (e.g., distributed around some or all of the vehicle). In some implementations, dynamic object detection and tracking can be performed using short-range radars (e.g., the dynamic object detection can cover tracking of one or more of pedestrians, cyclists, or vehicles).

In an operation 216, the process 200 can generate a notification to a user (e.g., by a mobile electronic device, or a vehicle computer interface) that the automatic closure feature will be available after a next drive cycle. That is, because the vehicle is not currently moving (according to the determination in the operation 210) the 3D surveillance of the surroundings may not be considered complete and therefore automatic closure actuation may be inhibited. When the outcome of the determination in the operation 210 is no, as in the example just described, the process 200 can also, by a branch 218, enter a state where the automatic closure actuation is disabled (until the next drive cycle).

When the outcome of the determination in the operation 210 is yes, an operation 220 can be performed that includes a determination of whether the vehicle speed is above a threshold limit. Any threshold can be used, including, but not limited to, about 10 kilometers per hour (km/h). When the outcome of the determination in the operation 220 is no, then in an operation 222 the process 200 can continue tracking objects and pedestrians around the vehicle using one or more sensors of the ADAS sensor suite. The tracking will enable the system to create a 3D map with depth information about the surroundings. In some implementations, an operation 224 is performed concurrently with, or subsequent to, the operation 222, and involves generating the 3D map. Any of multiple types of sensed information can be used, including, but not limited to, environmental detection, current pedestrian tracking, and/or current 3D object detection. In some implementations, the vehicle computer system includes a cache memory that can be written (and progressively rewritten) with the 3D map information.

When the outcome of the determination in the operation 220 is yes, an operation 226 can be performed where all detection and tracking algorithms are disabled. For example, when the vehicle travels with at least the threshold speed, it is less likely that it is immediately about to be parked and that a 3D map would be required for automatic closure activation. As such, the tracking can be disabled until the vehicle again travels below the threshold speed.

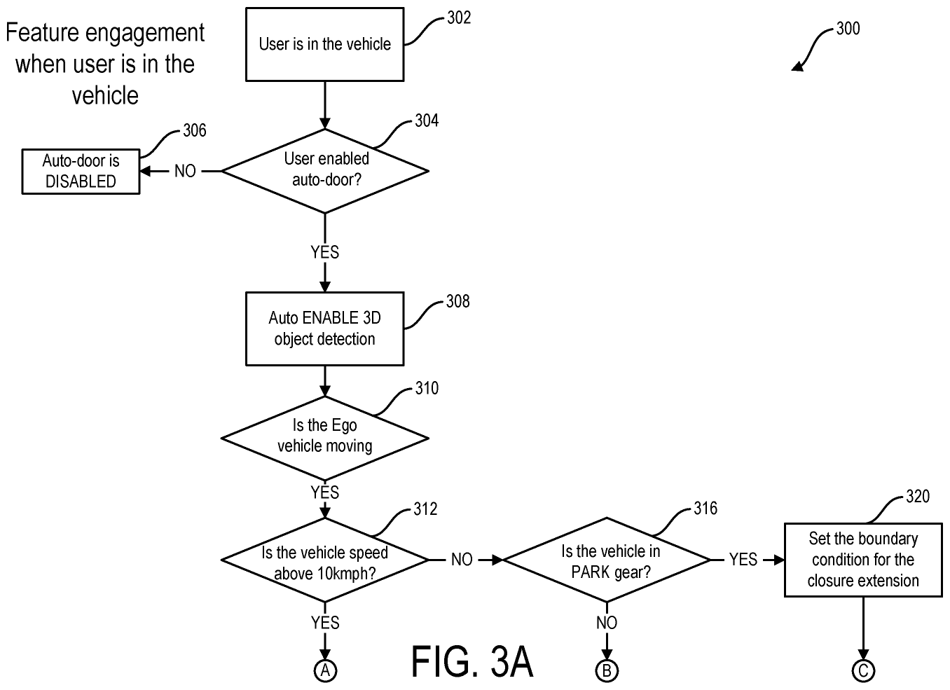

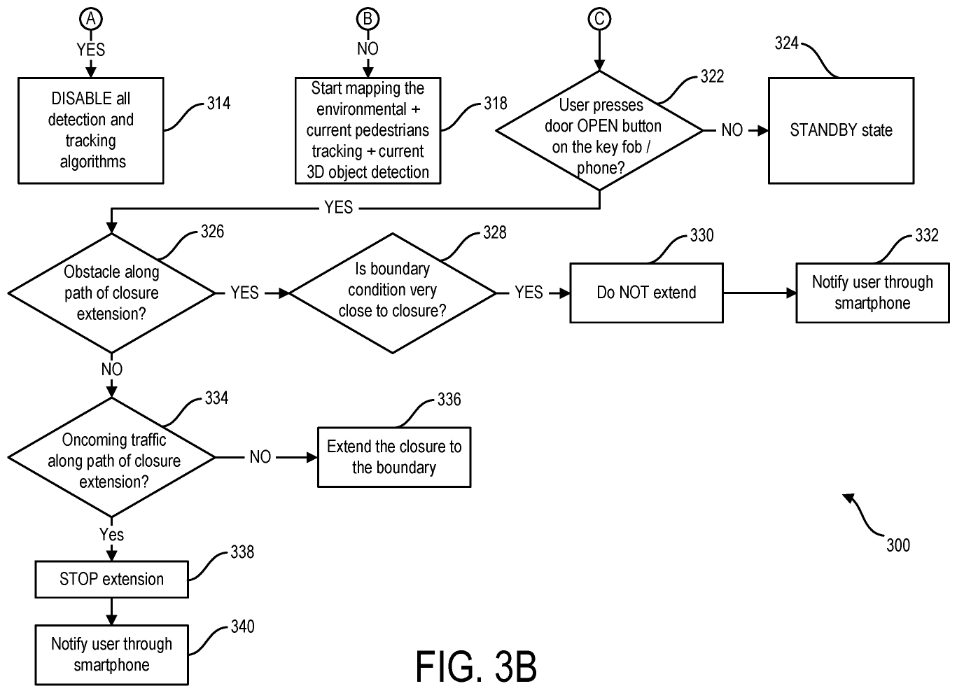

FIGS. 3A-3B show examples of a process 300 that can be applied for engaging, when a user is in a vehicle, a system that provides automatic closure operation. The process 300 can be used with one or more other examples described elsewhere herein. More or fewer operations than shown can be performed. Two or more operations can be performed in a different order unless otherwise indicated.

In operation 302, a user is inside the vehicle. In operation 304, the process 300 can determine whether an “auto-door” functionality has been enabled for a closure of the vehicle. If the outcome of the determination in the operation 304 is no, then in operation 306 the system state is that the auto-door functionality is currently disabled. If the outcome of the determination in the operation 304 is yes, then in operation 308 one or more detection functionalities can be enabled. In some implementations, 3D object detection is enabled. The 3D object detection can use one or more sensors of the ADAS sensor suite (e.g., one or more types of sensors) to detect the presence of any objects and possibly track their movement.

During the 3D object detection, an operation 310 can be performed where the process 300 determines whether the vehicle (sometimes referred to as the ego vehicle) is currently moving. If the outcome of the determination in the operation 310 is no, then automatic actuation of a closure may not currently be available while the vehicle is in motion.

On the other hand, if the outcome of the determination in the operation 310 is yes, then in operation 312 a determination of whether the vehicle speed is above a threshold limit can be performed. Any threshold can be used, including, but not limited to, about 10 km/h. When the outcome of the determination in the operation 312 is yes, then in an operation 314 all detection and tracking algorithms can be disabled.

When the outcome of the determination in the operation 312 is no, then in an operation 316 a determination can be performed whether the vehicle is presently in park gear. That is, while the vehicle may have been determined to have been moving in the operation 310, it is possible that the vehicle has come to a halt by the time of the operation 316 and is now in park mode. As another possibility, when the outcome of the determination in the operation 310 is no, the process can proceed directly to the operation 316. When the outcome of the determination in the operation 316 is no, then in an operation 318 a 3D map of the surroundings of the vehicle can be generated based on sensor data. Any of multiple types of sensed information can be used, including, but not limited to, environmental detection, current pedestrian tracking, and/or current 3D object detection. In some implementations, the vehicle computer system includes a cache memory that can be written (and progressively rewritten) with the 3D map information.

When the outcome of the determination in the operation 316 is yes, then in an operation 320 one or more boundary conditions for the closure actuation can be set regarding the vehicle based on the 3D map. In some implementations, a boundary polygon (e.g., the boundary polygon 120 in FIG. 1B) can be defined. The boundary condition(s) can then be applied before automatically actuating the closure.

After the operation 320, in an operation 322, a determination can be performed whether the user has activated the automatic closure actuation. In some implementations, the user performs such activation by pressing a button any other type of controller, or by performing a gesture that is detected by the system. For example, a key fob for the vehicle, and/or an executed application program coupled to the vehicle, can provide the button/controller. When the outcome of the determination in the operation 322 is no, then in an operation 324 the process 300 can bring the automatic closure actuation system to a standby state.

When the outcome of the determination in the operation 322 is yes, then in an operation 326 the process 300 can determine whether any obstacle exists along the path of the closure extension. Such an obstacle can include, but is not limited to, the pedestrian 128 in FIG. 1i, another vehicle (e.g., the vehicle 122 or 124 in FIG. 1), a fixed object (e.g., the pillar 126 in FIG. 1i), or a cyclist, to name just a few examples. When the outcome of the determination in the operation 326 is yes, then in an operation 328 the process 300 can determine whether the boundary condition (e.g., the boundary polygon 120 in FIG. 1B) is closer to the closure of the vehicle than a distance threshold. Any distance threshold can be used. When the outcome of the determination in the operation 328 is yes, then in an operation 330 the process 300 can inhibit the actuation of the closure. For example, if an extension of the closure (e.g., an opening of a door) was at issue, then such extension is not done as a result of the operation 330. In an operation 332 following the operation 330, the user can be notified about the inhibition (e.g., by a message presented on a mobile electronic device).

When the outcome of the determination in the operation 326 is no, then in an operation 334 the process 300 can determine whether there is oncoming traffic along the path of the closure extension. For example, when opening of a door is at issue, the operation 334 determines whether there is oncoming traffic in the path of the door's expected movement. When the outcome of the determination in the operation 334 is no, then in an operation 336 the process 300 can extend the closure to the boundary condition. That is, operation 336 involves controlling, based on the boundary conditions, a closure actuator that is configured for opening or closing the closure.

When the outcome of the determination in the operation 334 is yes, then in an operation 338 the process 300 can stop the extension of the closure. In an operation 340 following the operation 338, the user can be notified about the inhibition (e.g., by a message presented on a mobile electronic device).

The above example is described for the situation where a user is inside the vehicle and may wish to automatically actuate the closure. Such actuation can involve opening the closure (e.g., so the user inside the vehicle can egress through an opening created by extending the closure). Such actuation can also occur when the user inside the vehicle wishes to automatically close the closure. To the extent that the field(s) of view of the ADAS sensor suite will cover the gap between the extended closure and the opening in the vehicle body, a similar process to the process 300 can be performed for purposes of retracting the closure (e.g., for automatically closing the vehicle door). Otherwise, or in addition, the closure actuator may sense increased resistance if a person or an object is blocking the retracting motion of the closure (e.g., by sensing an increase in the electric current required for moving the closure) and can thereby interrupt the retraction based on the obstacle.

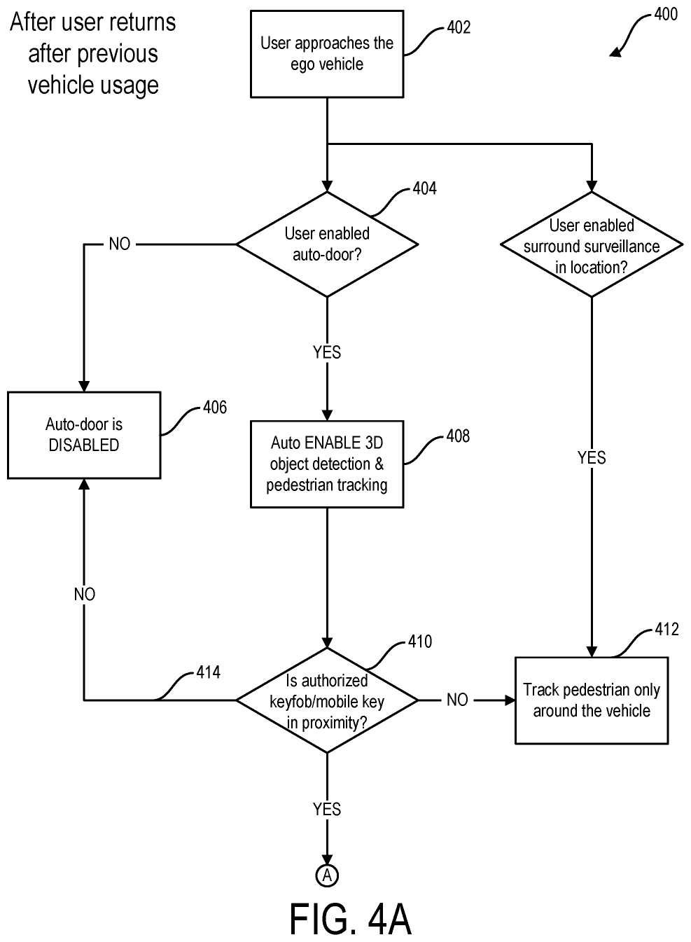

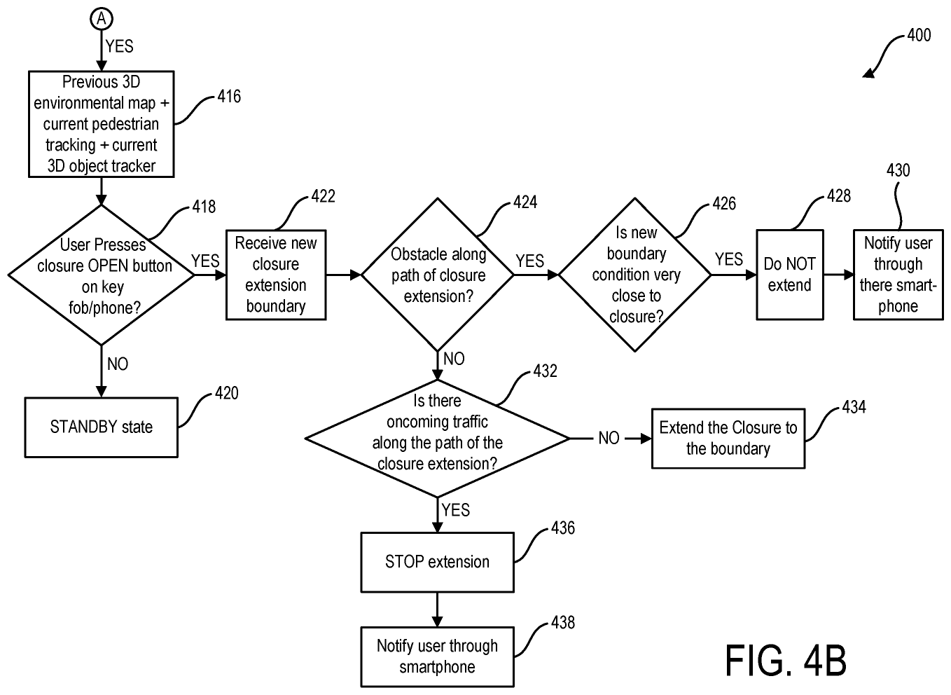

FIGS. 4A-4B show examples of a process 400 that can be applied for engaging, when a user returns to a vehicle, a system that provides automatic closure operation. The process 400 can be used with one or more other examples described elsewhere herein. More or fewer operations than shown can be performed. Two or more operations can be performed in a different order unless otherwise indicated.

In operation 402, a user approaches the vehicle. In operation 404, the process 400 can determine whether an “auto-door” functionality has been enabled for a closure of the vehicle. When the outcome of the determination in the operation 404 is no, then in operation 406 the system state is that the auto-door functionality is currently disabled. If the outcome of the determination in the operation 404 is yes, then in operation 408 one or more detection functionalities can be enabled. In some implementations, 3D object detection and pedestrian tracking are enabled. The detection/tracking can use one or more sensors of the ADAS sensor suite (e.g., one or more types of sensors) to detect the presence of any objects and track their movement.

In operation 410, the process 400 can perform a determination whether an authorized key is in proximity to the vehicle. For example, such an authorized key can be included in a key fob and/or can be stored on a mobile electronic device. When the outcome of the determination in the operation 410 is no, then in an operation 412 the process 400 can cause the system to only track pedestrians around (e.g., in the surroundings of) the vehicle. When the outcome of the determination in the operation 410 is no, as in the example just described, the process 400 can also, by a branch 414, enter a state where the automatic closure actuation is disabled.

When the outcome of the determination in the operation 410 is yes, then in an operation 416 the process 400 can access a previous 3D map for the vehicle and current tracking of pedestrians and/or objects. For example, the accessed information may at least in part have been collected based on the operation 408.

Following the operation 416, in an operation 418 the process 400 can perform a determination whether the user has activated the automatic closure actuation (e.g., by pressing a button). When the outcome of the determination in the operation 418 is no, then in an operation 420 the process 400 can cause the system to enter a standby state.

When the outcome of the determination in the operation 418 is yes, then in an operation 422 the process 400 can receive (e.g., generate or otherwise obtain) a new set of boundary conditions. The new boundary conditions may have been defined based on a new 3D map that takes into account recent sensor data from the ADAS sensor suite.

Following the operation 422, in an operation 424 the process 400 can determine whether any obstacle exists along the path of the closure extension. Such an obstacle can include, but is not limited to, the pedestrian 128 in FIG. 1B, another vehicle (e.g., the vehicle 122 or 124 in FIG. 1i), a fixed object (e.g., the pillar 126 in FIG. 1), or a cyclist, to name just a few examples. When the outcome of the determination in the operation 424 is yes, then in an operation 426 the process 400 can determine whether the boundary condition (e.g., the boundary polygon 120 in FIG. 1B) is closer to the closure of the vehicle than a distance threshold. When the outcome of the determination in the operation 426 is yes, then in an operation 428 the process 400 can inhibit the actuation of the closure. For example, if an extension of the closure (e.g., an opening of a door) was at issue, then such extension is not done as a result of the operation 428. In an operation 430 following the operation 428, the user can be notified about the inhibition (e.g., by a message presented on a mobile electronic device).

When the outcome of the determination in the operation 424 is no, then in an operation 432 the process 400 can determine whether there is oncoming traffic along the path of the closure extension. For example, when opening of a door is at issue, the operation 432 determines whether there is oncoming traffic in the path of the door's expected movement. When the outcome of the determination in the operation 432 is no, then in an operation 434 the process 400 can extend the closure to the boundary condition. That is, the operation 434 involves controlling, based on the boundary conditions, a closure actuator that is configured for opening or closing the closure.

When the outcome of the determination in the operation 432 is yes, then in an operation 436 the process 400 can stop the extension of the closure. In an operation 438 following the operation 436, the user can be notified about the inhibition (e.g., by a message presented on a mobile electronic device).

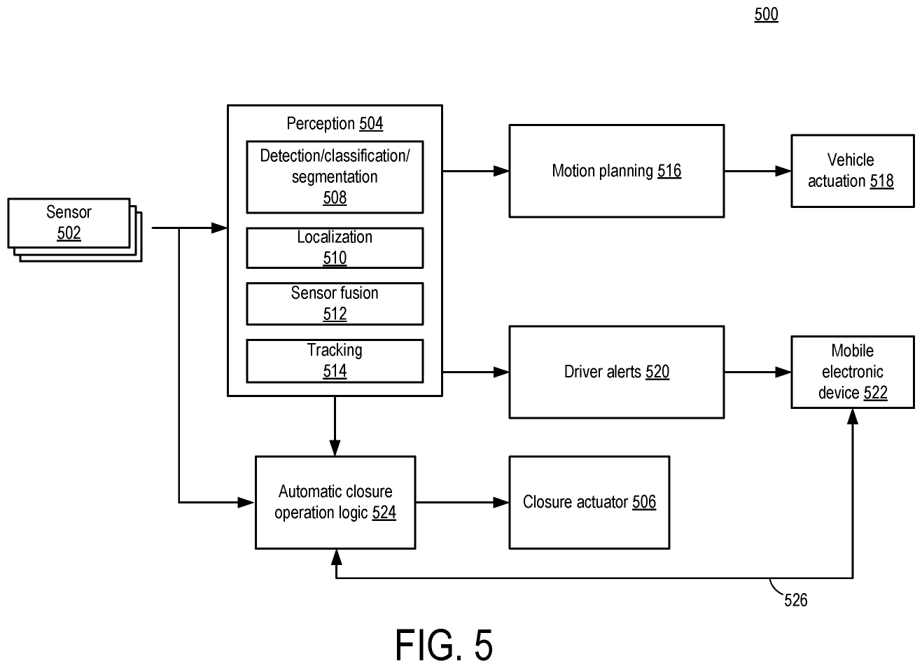

FIG. 5 shows an example of a system 500. The system 500 can be implemented as part of a vehicle and can be used with one or more other examples described elsewhere herein. Some aspects of the system 500 can be implemented using at least one processor that executes instructions stored in a non-transitory computer-readable medium. More or fewer components than shown can be used.

The system 500 in part includes an ADAS sensor suite 502. The ADAS sensor suite 502 can include a camera, ultrasonic sensors, and/or short-range radars. The ADAS sensor suite 502 can detect the surroundings of the vehicle. For example, the ADAS sensor suite 502 can have any or all of the POVs illustrated in FIG. 1A.

The system 500 includes a perception component 504 that receives sensor data from the ADAS sensor suite 502 and performs object detection and tracking. This can be used to help the system 500 plan how to control an ego vehicle's behavior and/or to control the operation of a closure actuator 506. The perception component 504 includes a component 508. For example, the component 508 can be configured to perform detection of objects (e.g., to distinguish the object from a road surface or other background). As another example, the component 508 can be configured to perform classification of objects (e.g., whether the object is a vehicle or a pedestrian). As another example, the component 508 can be configured to perform segmentation (e.g., to associate raw detection points into a coherent assembly to reflect the shape and pose of an object).

The perception component 504 can include a localization component 510. In some implementations, the localization component 510 serves to estimate the position of the vehicle substantially in real time. For example, the localization component 510 can use one or more sensor outputs, including, but not limited to, a global positioning system and/or a global navigation satellite system.

The perception component 504 can include a sensor fusion component 512. The sensor fusion component 512 can fuse the output from two or more sensors (e.g., any two or more of the sensors in the ADAS sensor suite 502) with each other in order to facilitate the operations of the perception component 504.

The perception component 504 can include a tracking component 514. In some implementations, the tracking component 514 can track objects in the surroundings of the vehicle for purposes of planning vehicle motion and/or controlling the operation of the closure actuator 506. For example, objects such as other vehicles, bicycles, and/or pedestrians can be tracked in successive instances of sensor data processed by the perception component 504.

The system 500 includes a motion planning component 516. The motion planning component 516 can plan for the system 500 to perform one or more actions, or to not perform any action, in response to monitoring of the surroundings of the vehicle and/or an input by the driver. For example, this can be done by making one or more predictions, and defining a path or trajectory for the vehicle accordingly. The system 500 includes a vehicle actuation component 518. The vehicle actuation component 518 can control one or more aspects of the vehicle according to the path/trajectory generated by the motion planning component 516. For example, the steering, gear selection, acceleration, and/or braking of the ego vehicle can be controlled.

The system 500 includes a driver alerts component 520. The driver alerts component 520 can use an alerting component in generating one or more alerts for a user. Any of multiple alert modalities (e.g., an audible, visual, and/or tactile alert) can be used. The system 500 includes mobile electronic device 522 that can receive and present the alert. For example, the mobile electronic device 522 includes a speaker, a display module, and/or a haptic actuator.

The system 500 includes logic 524 for automatically operating the closure actuator 506 and thereby controlling the closure of the vehicle. The logic 524 can receive some or all of the sensor data from the ADAS sensor suite 502, can interact with the perception component 504 (e.g., for tracking objects/pedestrians), can generate a 3D map of the surroundings of the vehicle using the sensor data, and can define one or more boundary conditions regarding the vehicle based on the 3D map. The logic 524 can control the closure actuator 506 based on the boundary condition(s), for example according to the examples described above with reference to the process 300 and/or 400. The closure actuator 506 can include an electric motor or other electromagnetic device, and/or hydraulics, that can be controlled for selectively actuating the closure in any of multiple positions. The closure may be articulated about one or more hinges, or may slide relative to a remainder of the vehicle, to name just a few examples. Communication between the mobile electronic device 522 and the logic 524 can occur and is indicated by an arrow 526. The communication can be transmitted by a wireless and/or wired connection, optionally through one or more networks. For example, the logic 524 can output an alert or other message to the user through the mobile electronic device 522. As another example, the mobile electronic device 522 can convey the user input of pressing a button or actuating another controller to the logic 524. In some implementations, the mobile electronic device 522 includes a key fob coupled to the vehicle. For example, the key fob can connect to the vehicle by near-field communication.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer-implemented method comprising:
collecting, in a vehicle having an advanced driver assistance system (ADAS), sensor data using an ADAS sensor suite of the vehicle, the sensor data collected while the vehicle is moving and reflecting surroundings of the vehicle;
generating a three-dimensional (3D) map of the surroundings using the sensor data;
defining a boundary condition regarding the vehicle based on the 3D map; and
controlling a closure actuator of a closure of the vehicle based on the boundary condition, the closure actuator configured for opening or closing the closure, the closure actuator controlled without the closure having any obstacle detection sensor.

2. The computer-implemented method of claim 1, wherein the ADAS sensor suite includes at least a camera and ultrasonic sensors, and wherein the camera and ultrasonic sensors are used in collecting the sensor data.

3. The computer-implemented method of claim 2, wherein the ADAS sensor suite further includes a radar, and wherein also the radar is used in collecting the sensor data.

4. The computer-implemented method of claim 3, wherein the radar is a short-range radar.

5. The computer-implemented method of claim 1, wherein collecting the sensor data comprises performing 3D tracking of the surroundings.

6. The computer-implemented method of claim 1, wherein defining the boundary condition comprises generating a boundary polygon surrounding the vehicle.

7. The computer-implemented method of claim 1, further comprising performing a determination that the vehicle is in park mode, wherein the boundary condition is defined in response to the determination.

8. The computer-implemented method of claim 1, wherein the closure includes a door of the vehicle.

9. The computer-implemented method of claim 1, wherein controlling the closure actuator based on the boundary condition comprises opening the closure.

10. The computer-implemented method of claim 1, wherein controlling the closure actuator based on the boundary condition comprises closing the closure.

11. The computer-implemented method of claim 1, further comprising receiving a user input to actuate the closure, wherein the closure actuator is controlled in response to receiving the user input.

12. The computer-implemented method of claim 11, wherein the user input is generated by an application that is executed by a vehicle system or that is executed by a mobile electronic device.

13. The computer-implemented method of claim 11, further comprising performing a first determination, in response to receiving the user input, whether an obstacle exists along a path of an extension of the closure.

14. The computer-implemented method of claim 13, wherein in response to the first determination indicating that the obstacle exists along the path, the method further comprises performing a second determination of whether the boundary condition is within a distance threshold of the closure.

15. The computer-implemented method of claim 14, wherein in response to the second determination indicating that the boundary condition is within the distance threshold of the closure, controlling the closure actuator comprises causing the closure actuator not to extend the closure.

16. The computer-implemented method of claim 13, wherein in response to the first determination indicating that the obstacle does not exist along the path, the method further comprises performing a second determination of whether oncoming traffic exists along the path of the extension of the closure.

17. The computer-implemented method of claim 16, wherein in response to the second determination indicating that the oncoming traffic does not exist along the path, controlling the closure actuator comprises causing the closure actuator to extend the closure.

18. The computer-implemented method of claim 16, wherein in response to the second determination indicating that the oncoming traffic exists along the path, controlling the closure actuator comprises causing the closure actuator not to extend the closure.

19. The computer-implemented method of claim 1, further comprising:
collecting new sensor data;
generating a new 3D map of the surroundings using the new sensor data;
defining a new boundary condition regarding the vehicle based on the new 3D map; and
controlling the closure actuator based on the new boundary condition, the closure actuator controlled without the closure having any obstacle detection sensor.

20. A vehicle comprising:
a vehicle body having a closure;
an advanced driver assistance system (ADAS);
an ADAS sensor suite configured for use by the ADAS, the ADAS sensor suite not including an obstacle detection sensor in the closure; and
closure operation logic implemented to be execute by at least one processor, the closure operation logic configured for i) collecting sensor data using the ADAS sensor suite while the vehicle is moving, the sensor data reflecting surroundings of the vehicle, ii) generating a three-dimensional (3D) map of the surroundings using the sensor data, iii) defining a boundary condition regarding the vehicle based on the 3D map, and iv) controlling a closure actuator of a closure of the vehicle based on the boundary condition, the closure actuator configured for opening or closing the closure.

21. The vehicle of claim 20, wherein the ADAS sensor suite includes at least a camera and ultrasonic sensors, and wherein the camera and ultrasonic sensors are used in collecting the sensor data.

22. The vehicle of claim 21, wherein the ADAS sensor suite further includes a radar, and wherein also the radar is used in collecting the sensor data.

23. The vehicle of claim 22, wherein the radar is a short-range radar.
